(19) United States
(12) Patent Application Publication
(10) Pub. No.: US 2026/0202436 A1
(43) Pub. Date: Jul. 16, 2026

(54) OBJECT MOVEMENT DETECTION APPARATUS, METHOD AND NON-TRANSITORY COMPUTER READABLE STORAGE MEDIUM

(71) Applicant: HTC Corporation, Taoyuan City (TW)

(72) Inventor: Yu-Hui HSU, Taoyuan City (TW)

(21) Appl. No.: 19/021,215

(22) Filed: Jan. 15, 2025

(51) Int. Cl. G01P 13/00

(52) U.S. Cl. CPC G01P 13/00

(57) ABSTRACT

An object movement detection apparatus and method are provided. The apparatus calculates a detected reference pose corresponding to the target object and the reference object when the target object is in a detecting state. In response to a difference between the detected reference pose and an initial reference pose being greater than a threshold, the apparatus determines that the target object is held.

### BACKGROUND

### Field of Invention

The present disclosure relates to an object movement detection apparatus and method. More particularly, the present disclosure relates to an object movement detection apparatus and method based on relative poses.

### Description of Related Art

In the existing technology, limited by specifications, three degrees of freedom (3DoF) data of an object is not enough to determine whether the object is taken and used by the user. To achieve the purpose, additional sensors are required to be installed on the object.

In addition, if it is interfered or used in unexpected situations, the sensors may cause misjudgments.

In view of this, how to provide reliable object movement detection technology that does not require additional sensors is the goal that the industry strives to work on.

### SUMMARY

The disclosure provides an object movement detection method, being adapted for use in an electronic apparatus, wherein the object movement detection method comprises the following steps: calculating a detected relative pose between a detected target pose of a target object and a detected reference pose of a reference object, wherein the detected target pose and the detected reference pose are measured when the target object is in a detecting state; and in response to a first difference between the detected relative pose and an initial relative pose being greater than a first threshold, determining that the target object is held and setting the target object to a held state.

The disclosure further provides an object movement detection apparatus comprising a communication interface and a processor. The communication interface is configured to communicatively connected to a target object and a reference object. The processor is electrically connected to the communication interface and configured to execute the following operations: calculating a detected relative pose between a detected target pose of the target object and a detected reference pose of the reference object, wherein the detected target pose and the detected reference pose are measured when the target object is in a detecting state; and in response to a first difference between the detected relative pose and an initial relative pose being greater than a first threshold, determining that the target object is held and setting the target object to a held state.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram illustrating an object movement detection apparatus according to a first embodiment of the present disclosure.

FIG. 2A is a schematic diagram illustrating a user wearing a target object and a reference object according to some embodiments of the present disclosure.

FIG. 2B is a schematic diagram illustrating the user holding the target object according to some embodiments of the present disclosure.

FIG. 3A is a schematic diagram illustrating a user wearing a target object and a reference object according to another embodiment of the present disclosure.

FIG. 3B is a schematic diagram illustrating the user holding the target object according to another embodiment of the present disclosure.

FIG. 4 is a schematic diagram illustrating the object movement detection apparatus determining whether the target object is held according to some embodiments of the present disclosure.

FIG. 5 is a schematic diagram illustrating the object movement detection apparatus setting the target object to initial state according to some embodiments of the present disclosure.

FIG. 6 is a schematic diagram illustrating the object movement detection apparatus determining whether the target object has been put back after being taken according to some embodiments of the present disclosure.

FIG. 7 is a schematic diagram illustrating inertial signals during the target object being dropped according to some embodiments of the present disclosure.

FIG. 8 is a schematic diagram illustrating the object movement detection apparatus setting the target object to dropped state according to some embodiments of the present disclosure.

FIG. 9 is a schematic diagram illustrating the object movement detection apparatus determining whether the target object is held or dropped according to some embodiments of the present disclosure.

FIG. 10 is a schematic diagram illustrating the object movement detection apparatus determining whether the target object has been put back after being dropped according to some embodiments of the present disclosure.

FIG. 11 is a schematic diagram illustrating the object movement detection apparatus determining whether the target object is held after being dropped according to some embodiments of the present disclosure.

FIG. 12 is a flow diagram illustrating an object movement detection method according to a second embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

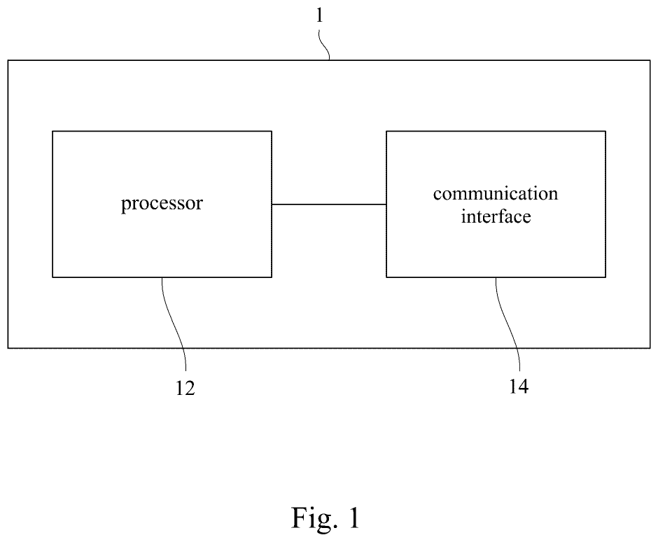

Please refer to FIG. 1, which is a schematic diagram illustrating an object movement detection apparatus 1 according to a first embodiment of the present disclosure. The object movement detection apparatus 1 comprises a processor 12 and a communication interface 14, wherein the processor 12 is electrically connected to the communication interface 14. The object movement detection apparatus 1 is configured to determine whether a target object is held by user. In some embodiments, the object movement detection apparatus 1 can be configured in a head-mounted display (HMD) or other apparatus to track the target object.

In some embodiments, the processor 12 comprises a central processing unit (CPU), a graphics processing unit (GPU), a multi-processor, a distributed processing system, an application specific integrated circuit (ASIC), and/or a suitable processing unit.

The communication interface 14 is configured to communicatively connected to a target object and a reference object, wherein the target object is a target for the object movement detection apparatus 1 to detect, and the reference object is a reference for relative poses.

In some embodiments, the communication interface 14 may comprise Ethernet, Bluetooth, Wi-Fi, and/or other wired or wireless data transmission interface and transmit and/or receive data to and/or from the target object and the reference object via corresponding communication protocol.

In some embodiments, the target object and the reference object comprise sensors configured to track poses respectively. For example, sensors may be image capture units for image tracking and/or inertial measurement units providing inertial data.

The target object and the reference object are configured to provide pose data to the object movement detection apparatus 1 via the communication interface 14 respectively. For example, the target object and the reference object provide inertial data measured by inertial measurement units continuously via streaming. Correspondingly, the object movement detection apparatus 1 is able to calculate 3DoF data of the target object and the reference object respectively based on the inertial data.

In some embodiments, the pose of the reference object may also be generated through measuring by other component. For example, the reference object is a non-electronic component, and an external camera transmits a reference object image or the reference object pose calculated based on the image to the object movement detection apparatus 1 after capturing the image of the reference object. Correspondingly, the object movement detection apparatus 1 may calculate the pose of the reference object based on the image or obtain the pose directly.

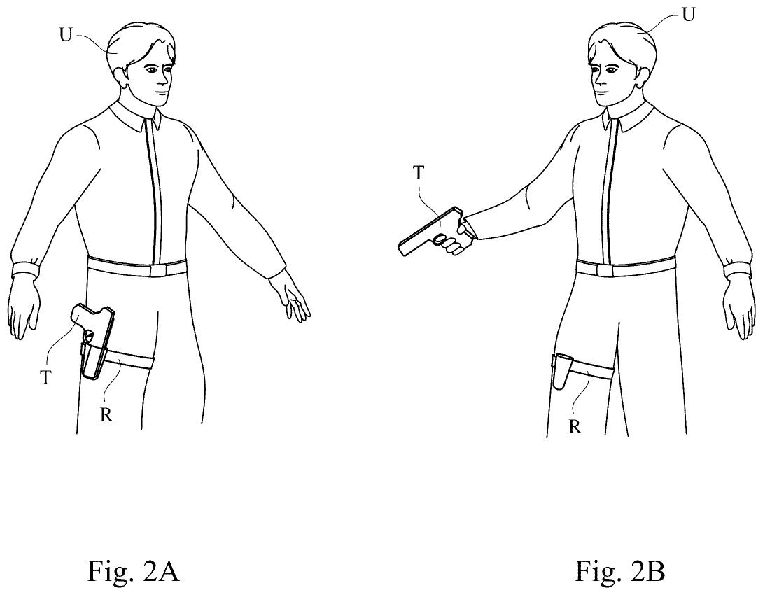

About the usage scenario of the object movement detection apparatus 1, please refer to FIG. 2A and FIG. 2B, wherein FIG. 2A illustrates a user U wearing a target object T and a reference object R, and FIG. 2B illustrates the user U holding the target object T correspondingly.

In the embodiments shown in FIG. 2A and FIG. 2B, the target object T is a handgun, the reference object R is a holster strapped to a thigh of the user U, and the handgun can be placed in the holster (as shown in FIG. 2A). When the user U has not pick up the handgun, the target object T and the reference object R will move and rotate synchronously because they are fixed together (as shown in FIG. 2A) and further maintaining a similar relative pose. Relatively, when the user U picks up the handgun from the holster, the target object T will present different pose changes relative to the reference object R according to the action of the user U (as shown in FIG. 2B).

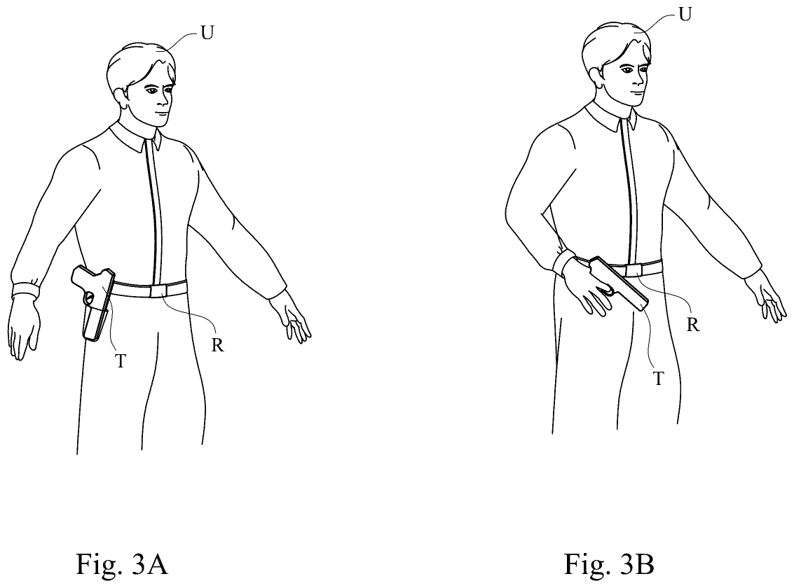

About another usage scenario of the object movement detection apparatus 1, please refer to FIG. 3A and FIG. 3B, wherein FIG. 3A illustrates a user U wearing a target object T and a reference object R, and FIG. 3B illustrates the user U holding the target object T correspondingly.

Similarly, in the embodiments shown in FIG. 3A and FIG. 3B, the target object T is a handgun, the reference object R is a belt tied around the waist of the user U, and the handgun can be placed in the holster on the belt (as shown in FIG. 3A). When the user U has not pick up the handgun, the target object T and the reference object R will move and rotate synchronously because they are fixed together (as shown in FIG. 3A) and further maintaining a similar relative pose. Relatively, when the user U picks up the handgun from the holster, the target object T will present different pose changes relative to the reference object R according to the action of the user U (as shown in FIG. 3B).

In the embodiment, the sensor of the reference object R is configured in the belt buckle in front of the abdomen of the user U (i.e., the position indicated by the label R in FIG. 3A). It can be seen in FIG. 3A, when the handgun is placed in the holster, the poses measured by the sensors configured in the target object T and the reference object R will change synchronously with the movement of the user U. Relatively, when the user U picks up the handgun, the pose measured by the sensor configured in the target object T will produce different changes from the pose measured by the sensor configured in the reference object R.

According to the pose changes characteristic between the target object T and the reference object R in the aforementioned embodiments, the object movement detection apparatus 1 is able to determine whether the target object T is held (by the user U or others) based on the relative pose between the target object T and the reference object R.

For example, while the relative pose between the target object T and the reference object R changes only slightly, the object movement detection apparatus 1 determines that the target object T has not been held. Relatively, when the relative pose changes significantly, the object movement detection apparatus 1 determines that the target object T is held.

Specifically, the processor 12 is configured to execute the following operations: calculating a detected relative pose between a detected target pose of the target object and a detected reference pose of the reference object, wherein the detected target pose and the detected reference pose are measured when the target object is in a detecting state; and in response to a first difference between the detected relative pose and an initial relative pose being greater than a first threshold, determining that the target object is held and setting the target object to a held state.

Accordingly, through comparing the relative pose while the target object T is placed at the original position and the relative pose during detection, the object movement detection apparatus 1 is able to detect whether the target object T is held.

In some embodiments, in order to obtain the initial relative pose, the object movement detection apparatus 1 calculates an initial relative pose of the target object T and the reference object R as a basis for subsequent determination while the target object T has not been held (e.g., the scenarios shown in FIG. 2A and/or FIG. 3A). Furthermore, after calculating the initial relative pose, the object movement detection apparatus 1 sets the target object T to the detecting state to start the detection.

Specifically, the processor 12 is configured to execute the following operations: calculating the initial relative pose between an initial target pose of the target object and an initial reference pose of the reference object, wherein the initial target pose and the initial reference pose are measured when the target object is in an initial state; and after calculating the initial relative pose, setting the target object to the detecting state.

After calculating the initial relative pose, the object movement detection apparatus 1 starts to detect whether the target object T is held. The object movement detection apparatus 1 calculates the relative pose of the target object T and the reference object R and determines the difference between the calculated relative pose and the initial relative pose. If the difference is greater than a certain value, the object movement detection apparatus 1 determines that the target object T is held.

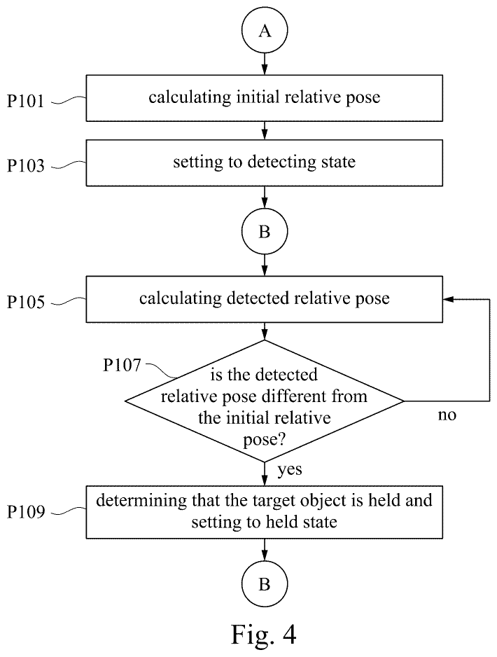

In order to illustrate the above operations more specifically, please refer to FIG. 4, which is a schematic diagram illustrating the object movement detection apparatus 1 determining whether the target object is held according to some embodiments of the present disclosure.

First, the object movement detection apparatus 1 executes operation P101, calculating an initial relative pose of the target object T and the reference object R. In the meantime, the target object T is placed in an initial position and has not been taken by the user U.

Next, the object movement detection apparatus 1 executes operation P103, setting the target object T to a detecting state. In the meantime, the object movement detection apparatus 1 starts to determine whether the target object T is held.

Next, the object movement detection apparatus 1 executes operation P105, calculating a detected relative pose of the target object T and the reference object R.

Correspondingly, the object movement detection apparatus 1 further executes operation P107, determining whether the detected relative pose is different from the initial relative pose. If the difference is greater than the first threshold, the object movement detection apparatus 1 then executes operation P109, determining that the target object T is held and setting the target object T to the held state. Relatively, if the difference is not greater than the first threshold, the object movement detection apparatus 1 returns to the operation P105, continuing to calculate the detected relative pose.

Based on the embodiment above, the object movement detection apparatus 1 is able to determine whether the target object T is held. Practically, the object movement detection apparatus 1 can be applied to interactive apparatuses such as game object. Also, the object movement detection apparatus 1 can be applied to objects can be manipulated by user when held, such as guns and sports equipment.

It is noted that, the relative pose of the target object T and the reference object R (e.g., the initial relative pose and the detected relative pose) can be represented in a format of quaternion and/or matrix to indicate the position and/or orientation relationship between the target object T and the reference object R. In some embodiments, the object movement detection apparatus 1 calculates the relative pose based on the 3DoF poses of the target object T and the reference object R.

On the other hand, the object movement detection apparatus 1 may calculate the difference values of distance and/or angle by subtracting two relative poses and take the difference values as the difference between the relative poses.

In some embodiments, before setting the target object T to the initial state, the object movement detection apparatus 1 determines whether the changes of the relative pose of the target object T and the reference object R is stable and able to calculate a reliable initial relative pose.

Specifically, the processor 12 is further configured to execute the following operations: calculating a plurality of first relative poses between a plurality of first target poses of the target object and a plurality of first reference poses of the reference object, wherein the first target poses and the first reference poses are measured within a time interval; and in response to a second difference between the first relative poses being lower than a second threshold, setting the target object to an initial state.

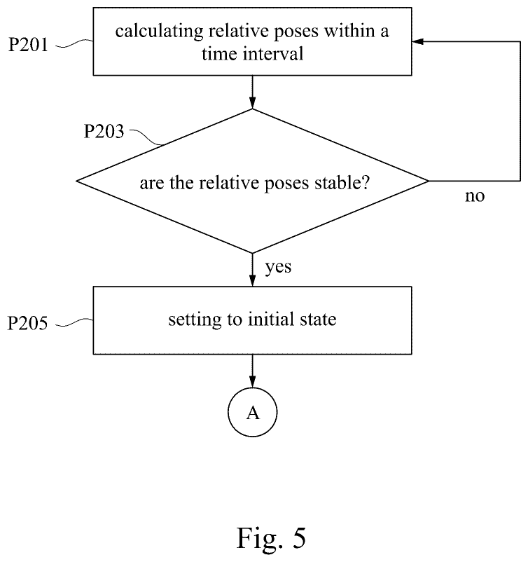

About the specific operation of the object movement detection apparatus 1 setting the target object T to the initial state, please refer to FIG. 5.

First, in operation P201, the object movement detection apparatus 1 starts to track the poses of the target object T and the reference object R and calculates the relative poses of them (e.g., calculating a set of relative pose per 10 milliseconds).

Next, in operation P203, the object movement detection apparatus 1 determines whether the relative poses are stable. For example, the object movement detection apparatus 1 calculates the relative pose changes within multiple time points. If the relative pose difference within a time interval (e.g., 0.5 seconds) is less than the second threshold (e.g., the angle difference is less than 5 degrees), the object movement detection apparatus 1 determines that the relative poses between the target object T and the reference object R are stable. Accordingly, the object movement detection apparatus 1 executes operation P205, setting the target object T to the initial state to calculate the initial relative pose. On the contrary, if the relative poses are not stable, the object movement detection apparatus 1 returns to the operation P201 and continues to calculate the relative poses.

According to the embodiment above, the object movement detection apparatus 1 is able to determine whether to set the target object T to the initial state. After setting the target object T to the initial state, as shown in FIG. 5, the object movement detection apparatus 1 enters node A and executes the operation P101 shown in FIG. 4 subsequently.

In some embodiments, after determining that the target object T is held, the object movement detection apparatus 1 starts to detect whether the target object T continues to be held or is placed again (e.g., the scenarios shown in FIG. 2A and/or FIG. 3A).

Specifically, the processor 12 is further configured to execute the following operations: calculating a held relative pose between a held target pose of the target object and a held reference pose of the reference object, wherein the held target pose and the held reference pose are measured when the target object is in the held state; and in response to a third difference between the held relative pose and the initial relative pose being lower than a third threshold, setting the target object to the detecting state.

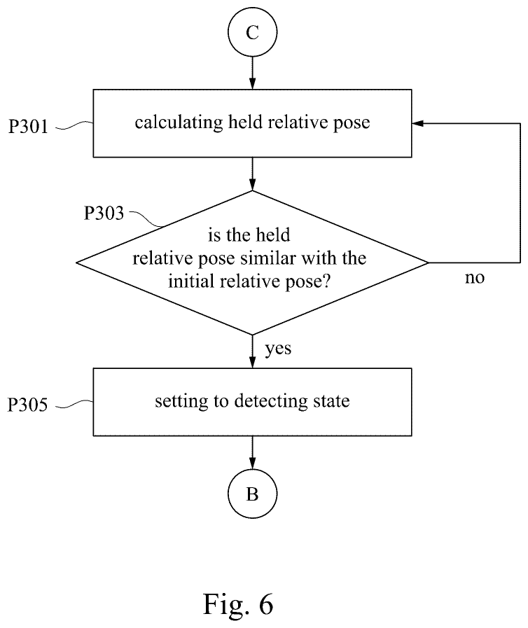

About the specific operation of the object movement detection apparatus 1 determining whether the target object T has been put back after the target object T is taken and held, please refer to FIG. 6.

First, in operation P301, after the target object T is taken, the object movement detection apparatus 1 continues to track the poses of the target object T and the reference object R and calculate the held relative pose of them.

Next, in operation P303, the object movement detection apparatus 1 determines whether the held relative pose is similar with the initial relative pose. For example, the object movement detection apparatus 1 calculates the difference between the held relative pose and the initial relative pose. If the difference is lower than the third threshold, it is indicated that the user U may have put the target object T back to the original position (e.g., putting the handgun back to the holster). Therefore, the object movement detection apparatus 1 determines that the target object T stops being held by the user U and further executes operation P305. Relatively, if the difference is not lower than the third threshold, it is indicated that the user U may still be holding the target object T. Therefore, the object movement detection apparatus 1 returns to the operation P301 to continue to calculate the held relative pose.

Correspondingly, in the operation P305, the object movement detection apparatus 1 resets the target object T to the detecting state. Furthermore, as shown in FIG. 6, the object movement detection apparatus 1 enters node B and executes the operation P105 shown in FIG. 4 subsequently.

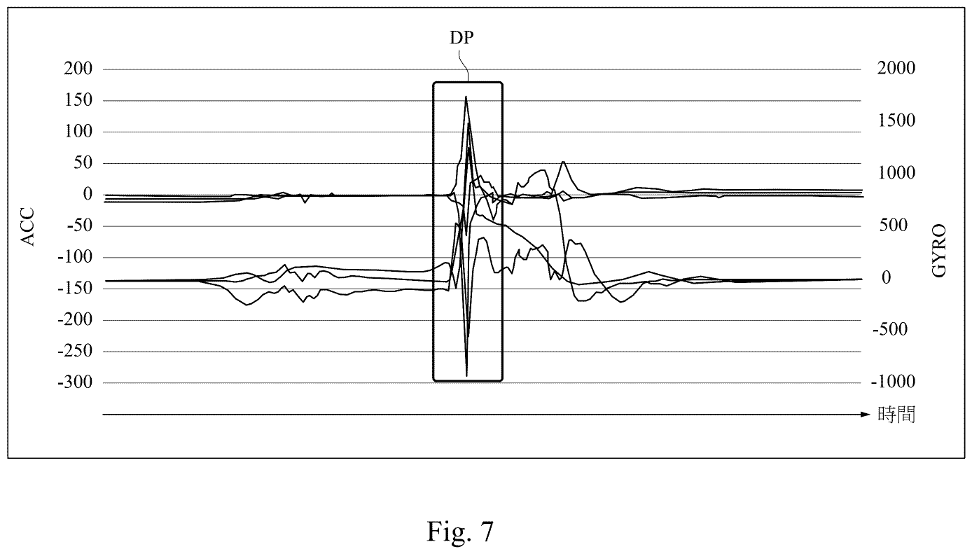

In some embodiments, if the target object T falls accidently, the object movement detection apparatus 1 may misjudge that the target object T is held. Please further refer to FIG. 7, which is a schematic diagram illustrating inertial signals during the target object T being dropped according to some embodiments of the present disclosure. As shown in the figure, the inertial data DP of the target object T changes significantly when the target object T is dropped, wherein the inertial data comprises angular velocities (referring to the right vertical axis GYRO) and accelerations (referring to the left vertical axis ACC) on x, y, and z axes. Accordingly, the object movement detection apparatus 1 is able to determine whether the target object T is dropped based on the inertial data DP of the target object T.

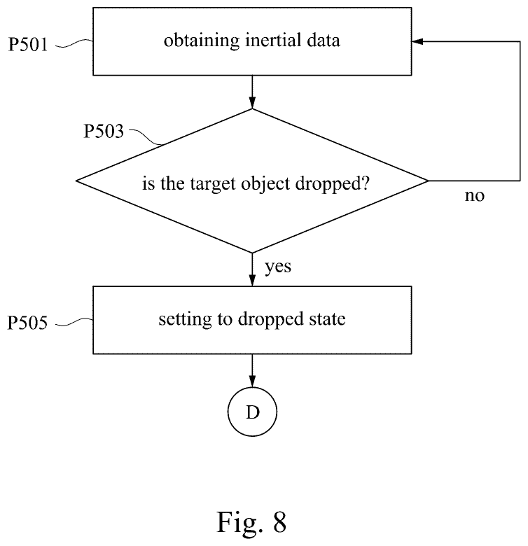

About the specific operation of determining whether the target object T is dropped, please refer to FIG. 8.

First, in operation P501, the object movement detection apparatus 1 continues to obtain the inertial data of the target object T, e.g., the communication interface 14 receives the inertial data measured by an inertial measurement unit from the target object T.

Next, in operation P503, the object movement detection apparatus 1 determines whether the target object T is dropped based on the inertial data.

The object movement detection apparatus 1 can determine whether the target object T is dropped in different ways. For example, since the inertial data will change significantly while dropped, the object movement detection apparatus 1 determines the target object T is dropped when the value of the inertial data (e.g., an absolute value of angular velocity and/or acceleration on one or more axis) exceeds a certain value.

Specifically, the processor 12 is further configured to execute the following operations: obtaining an inertial data measured by an inertial measurement unit of the target object; and in response to the inertial data being greater than an inertial threshold, setting the target object to a dropped state.

In another example, since the inertial data while the target object T dropped has specific features, the object movement detection apparatus 1 can also determine whether the target object T is dropped by using a machine learning model.

Specifically, the processor 12 is further configured to execute the following operations: obtaining an inertial data measured by an inertial measurement unit of the target object; and determining whether to set the target object to a dropped state by using a detection model based on the inertial data.

It is noted that, the detection model can be generated after training a machine learning model by using multiple inertial data measured while the target object T or other item is dropped as training data.

Please return to FIG. 8, after determining that the target object T is dropped in the operation P503, the object movement detection apparatus 1 further executes operation P505 and sets the target object T as the dropped state. Relatively, if determining that the target object T is not dropped, the object movement detection apparatus 1 returns to the operation P501 and continues to determine whether the target object T is dropped.

The object movement detection apparatus 1 can determine whether the target object T is dropped at different time points. In some embodiments, since the relative pose while the target object T is dropped is different from the initial relative pose, the object movement detection apparatus 1 will determine whether the target object T is dropped after determining the target object T may be held (e.g., determining “yes” in the operation P107 shown in FIG. 4). After that, the object movement detection apparatus 1 determines setting the target object T to the held state or the dropped state then.

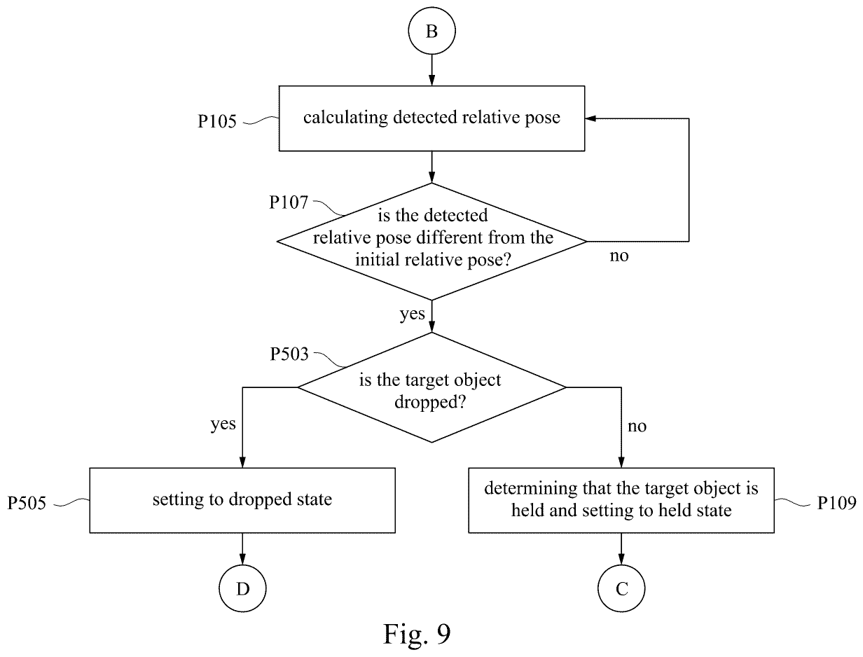

Please refer to FIG. 9, combining the embodiments of FIG. 4 and FIG. 8, after executing the operations P105 and P107, if determining that the difference between the detected relative pose and the initial relative pose is greater than a threshold, the object movement detection apparatus 1 executes the operation P503. Furthermore, if determining that the target object T meets the dropped characteristic, the object movement detection apparatus 1 executes the operation P505 to set the target object T to the dropped state. Relatively, if determining that the target object T does not meet the dropped characteristic, the object movement detection apparatus 1 executes the operation P109 to determine that the target object T is held and set the target object T to the held state.

Specifically, the operation of determining that the target object is held further comprises: in response to the first difference being greater than the first threshold, determining whether the target object is in a dropped state based on an inertial data of the target object; and in response to the target object is not in a dropped state, determining that the target object is held and setting the target object to the held state.

It is noted that, the details of each operations shown in FIG. 9 are similar with the aforementioned embodiments, and the similarities will not be repeated again. In some examples, the object movement detection apparatus 1 executes the operation P501 shown in FIG. 8 before executing the operation P503 to obtain the required inertial data.

In some embodiments, after setting the target object T to the dropped state, the object movement detection apparatus 1 further detects whether the target object T has been put back to the original position.

Specifically, the processor 12 is further configured to execute the following operations: calculating a dropped relative pose between a dropped target pose of the target object and a dropped reference pose of the reference object, wherein the dropped target pose and the dropped reference pose are measured when the target object is in a dropped state; and in response to a fourth difference between the dropped relative pose and the initial relative pose being lower than a fourth threshold, setting the target object to the detecting state.

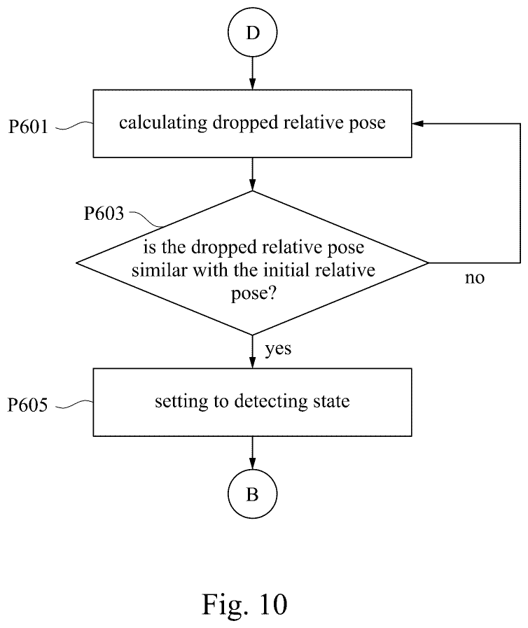

Please refer to FIG. 10 for details of specific operations, following the embodiments shown in FIG. 8 and/or FIG. 9, after the operation of the object movement detection apparatus 1 enters node D, the object movement detection apparatus 1 may also execute operation P601, calculating the relative pose of the target object T after the target object T being dropped (i.e., the dropped relative pose).

Furthermore, the object movement detection apparatus 1 executes operation P603, determining whether the dropped relative pose is similar with the initial relative pose, wherein the operation P603 can be implemented based on the operation P303 shown in FIG. 6.

If the dropped relative pose is similar with the initial relative pose, the object movement detection apparatus determines that the target object T has been put back to the original position and sets the target object T to the detecting state in operation P605. After that, the object movement detection apparatus 1 may further enter the node B and return to the operations shown in FIG. 4 or FIG. 9. Relatively, if there is a certain amount of difference between the dropped relative pose and the initial relative pose, the object movement detection apparatus 1 determines that the target object T is not placed at the original position and returns to the operation P601 to continue the detection.

In some embodiments, after setting the target object T to the dropped state, the object movement detection apparatus 1 further detects whether the target object T has been taken by the user U.

Specifically, the processor 12 is further configured to execute the following operations: in response to setting the target object to a dropped state, obtaining an inertial data measured by an inertial measurement unit of the target object; determining whether the target object is moved based on the inertial data; and in response to determining the target object is moved, setting the target object to the held state.

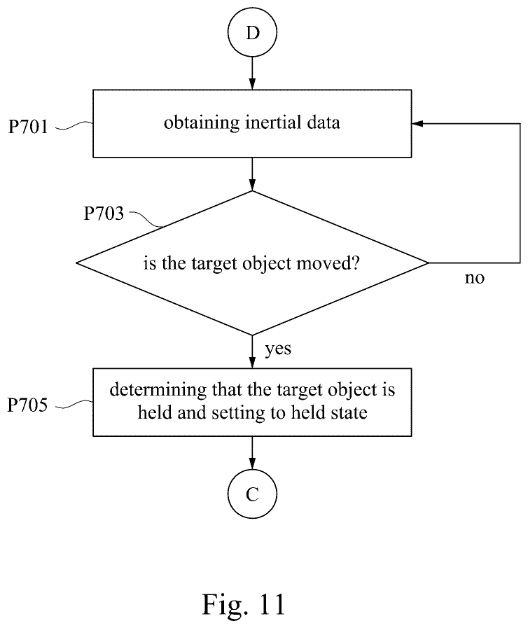

Please refer to FIG. 11 for details of specific operations, following the embodiments shown in FIG. 8 and/or FIG. 9, after the operation of the object movement detection apparatus 1 enters node D, the object movement detection apparatus 1 may also execute operation P701, obtaining the inertial data of the target object T.

Furthermore, the object movement detection apparatus 1 executes operation P703, determining whether the target object T is moved based on the value of the inertial data (e.g., after the target object T has dropped, there are still changes in the value of acceleration and/or angular velocity).

If determining the target object T is moved, it is indicated that the target object T may be taken by the user U, and the object movement detection apparatus 1 determines that the target object T is held and sets the target object T to the held state. After that, the object movement detection apparatus 1 may further enter the node C and return to the operations shown in FIG. 6. Relatively, if determining that the target object T is not moved, the object movement detection apparatus 1 returns to the operation P701 to continue the detection.

Through the aforementioned embodiments, the object movement detection apparatus 1 is able to determine whether the target object T is in the initial state, the held state, or the dropped state. Accordingly, the object movement detection apparatus 1 can also adopt different control operations on the target object T for different states.

In some embodiments, after setting the target object T to the held state, the object movement detection apparatus 1 further determines the pose of the target object T based on the hand pose of the user U or determines the hand pose of the user U based on the pose of the target object T, and then rendering virtual objects corresponding the target object T and/or the hand of the user U accordingly.

Specifically, the processor 12 is further configured to execute the following operation: in response to setting the target object to the held state, determining an object pose of the target object based on a part posture of a user.

For example, if the object movement detection apparatus 1 can only obtain 3DoF data of the target object T but is able to obtain 6DoF pose of the user U in a three-dimensional space through image tracking or other method, in when the target object T is held, the object movement detection apparatus 1 is able to track the hand of the user U holding the target object T and take the hand pose as the 6DoF pose of the target object T. Accordingly, the object movement detection apparatus 1 can still obtain more specific pose data of the target object T without configuring additional sensors.

In some embodiments, after setting the target object T to the held state, the object movement detection apparatus 1 unlocks at least one function of the target object T.

Specifically, the processor 12 is further configured to execute the following operation: in response to setting the target object to the held state, unlocking a function of the target object.

For example, while the user U is holding the target object T, it is indicated that the user U is using the target object T, and the object movement detection apparatus 1 unlocks some of the functions. For example, activating the auxiliary components on a gun, activating the sensors on the target object T, etc.

Relatively, in some embodiments, when the target object T is determined dropped or place at the original position, the object movement detection apparatus 1 may lock some of the function of the target object T to avoid false triggered, used by others, or wasting power. For example, turning on the safety switch of a gun, turning off the components and/or sensors.

In summary, the object movement detection apparatus 1 provided by the present disclosure is able to determine the state of the target object based on the relative pose of the target object and the reference object, comprising whether the target object is held, dropped, or placed at the original position. The object movement detection apparatus 1 does not require additional sensors configured in the target object, so there is no misjudgments due to the sensor being interfered. Furthermore, the object movement detection apparatus 1 can adopt different control operations based on different states corresponding to the target object.

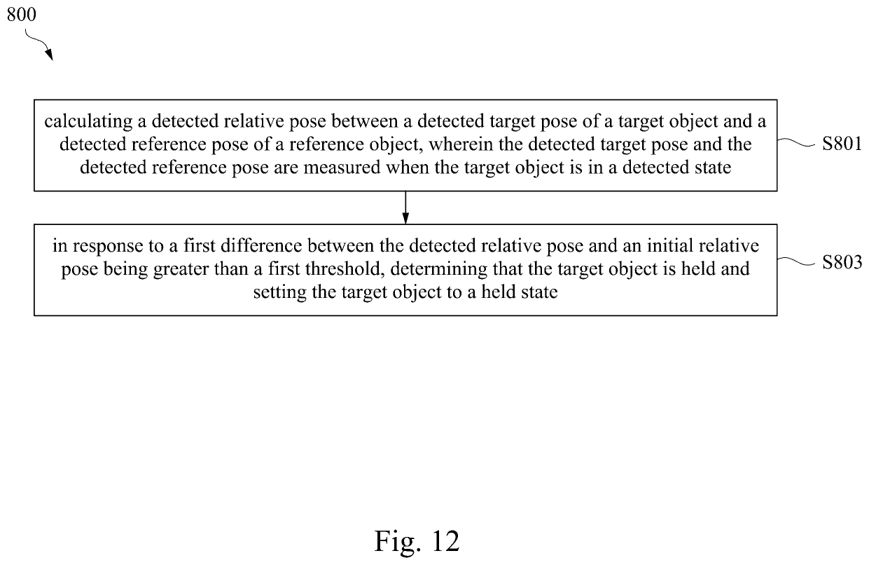

Please refer to FIG. 12, which is a flow diagram illustrating an object movement detection method 800 according to a second embodiment of the present disclosure. The object movement detection method 800 comprises steps S801 and S803. The object movement detection method 800 is configured to determine whether a target object is held. The object movement detection method 800 can be executed by an electronic apparatus (e.g., the object movement detection apparatus 1 in the first embodiment).

First, in the step S801, the electronic apparatus calculates a detected relative pose between a detected target pose of the target object and a detected reference pose of the reference object, wherein the detected target pose and the detected reference pose are measured when the target object is in the detecting state.

Finally, in the step 803, in response to a first difference between the detected relative pose and the initial relative pose being greater than a first threshold, the electronic apparatus determines that the target object is held and setting the target object to a held state.

In some embodiments, the object movement detection method 800 further comprises the electronic apparatus calculates an initial relative pose between an initial target pose of a target object and an initial reference pose of a reference object, wherein the initial target pose and the initial reference pose are measured when the target object is in an initial state; and after calculating the initial relative pose, the electronic apparatus sets the target object to a detecting state.

In some embodiments, the object movement detection method 800 further comprises the electronic apparatus calculating a plurality of first relative poses between a plurality of first target poses of the target object and a plurality of first reference poses of the reference object, wherein the first target poses and the first reference poses are measured within a time interval; and in response to a second difference between the first relative poses being lower than a second threshold, the electronic apparatus setting the target object to an initial state.

In some embodiments, the object movement detection method 800 further comprises the electronic apparatus calculating a held relative pose between a held target pose of the target object and a held reference pose of the reference object, wherein the held target pose and the held reference pose are measured when the target object is in the held state; and in response to a third difference between the held relative pose and the initial relative pose being lower than a third threshold, the electronic apparatus setting the target object to the detecting state.

In some embodiments, the step S807 further comprises in response to the first difference being greater than the first threshold, the electronic apparatus determining whether the target object is in a dropped state based on an inertial data of the target object; and in response to the target object is not in a dropped state, the electronic apparatus determining that the target object is held and setting the target object to the held state.

In some embodiments, the object movement detection method 800 further comprises the electronic apparatus obtaining an inertial data measured by an inertial measurement unit of the target object; and in response to the inertial data being greater than an inertial threshold, the electronic apparatus setting the target object to a dropped state.

In some embodiments, the object movement detection method 800 further comprises the electronic apparatus obtaining an inertial data measured by an inertial measurement unit of the target object; and the electronic apparatus determining whether to set the target object to a dropped state by using a detection model based on the inertial data.

In some embodiments, the object movement detection method 800 further comprises the electronic apparatus calculating a dropped relative pose between a dropped target pose of the target object and a dropped reference pose of the reference object, wherein the dropped target pose and the dropped reference pose are measured when the target object is in a dropped state; and in response to a fourth difference between the dropped relative pose and the initial relative pose being lower than a fourth threshold, the electronic apparatus setting the target object to the detecting state.

In some embodiments, the object movement detection method 800 further comprises in response to setting the target object to a dropped state, the electronic apparatus obtaining an inertial data measured by an inertial measurement unit of the target object; the electronic apparatus determining whether the target object is moved based on the inertial data; and in response to determining the target object is moved, the electronic apparatus setting the target object to the held state.

In some embodiments, the object movement detection method 800 further comprises in response to setting the target object to the held state, the electronic apparatus determining an object pose of the target object based on a part posture of a user.

In some embodiments, the object movement detection method 800 further comprises in response to setting the target object to the held state, the electronic apparatus unlocking a function of the target object.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An object movement detection method, being adapted for use in an electronic apparatus, wherein the object movement detection method comprises the following steps:
calculating a detected relative pose between a detected target pose of a target object and a detected reference pose of a reference object, wherein the detected target pose and the detected reference pose are measured when the target object is in a detecting state; and
in response to a first difference between the detected relative pose and an initial relative pose being greater than a first threshold, determining that the target object is held and setting the target object to a held state.

2. The object movement detection method of claim 1, further comprising:
calculating the initial relative pose between an initial target pose of the target object and an initial reference pose of the reference object, wherein the initial target pose and the initial reference pose are measured when the target object is in an initial state; and
after calculating the initial relative pose, setting the target object to the detecting state.

3. The object movement detection method of claim 2, further comprising:
calculating a plurality of first relative poses between a plurality of first target poses of the target object and a plurality of first reference poses of the reference object, wherein the first target poses and the first reference poses are measured within a time interval; and
in response to a second difference between the first relative poses being lower than a second threshold, setting the target object to an initial state.

4. The object movement detection method of claim 1, further comprising:
calculating a held relative pose between a held target pose of the target object and a held reference pose of the reference object, wherein the held target pose and the held reference pose are measured when the target object is in the held state; and
in response to a third difference between the held relative pose and the initial relative pose being lower than a third threshold, setting the target object to the detecting state.

5. The object movement detection method of claim 1, wherein the step of determining that the target object is held further comprises:
in response to the first difference being greater than the first threshold, determining whether the target object is in a dropped state based on an inertial data of the target object; and
in response to the target object is not in a dropped state, determining that the target object is held and setting the target object to the held state.

6. The object movement detection method of claim 1, further comprising:
obtaining an inertial data measured by an inertial measurement unit of the target object; and
in response to the inertial data being greater than an inertial threshold, setting the target object to a dropped state.

7. The object movement detection method of claim 1, further comprising:
obtaining an inertial data measured by an inertial measurement unit of the target object; and
determining whether to set the target object to a dropped state by using a detection model based on the inertial data.

8. The object movement detection method of claim 1, further comprising:
calculating a dropped relative pose between a dropped target pose of the target object and a dropped reference pose of the reference object, wherein the dropped target pose and the dropped reference pose are measured when the target object is in a dropped state; and
in response to a fourth difference between the dropped relative pose and the initial relative pose being lower than a fourth threshold, setting the target object to the detecting state.

9. The object movement detection method of claim 1, further comprising:
in response to setting the target object to a dropped state, obtaining an inertial data measured by an inertial measurement unit of the target object;
determining whether the target object is moved based on the inertial data; and
in response to determining the target object is moved, setting the target object to the held state.

10. The object movement detection method of claim 1, further comprising:
in response to setting the target object to the held state, determining an object pose of the target object based on a part posture of a user.

11. An object movement detection apparatus, comprising:
a communication interface, configured to communicatively connected to a target object and a reference object; and
a processor, electrically connected to the communication interface, configured to execute the following operations:
calculating a detected relative pose between a detected target pose of the target object and a detected reference pose of the reference object, wherein the detected target pose and the detected reference pose are measured when the target object is in a detecting state; and
in response to a first difference between the detected relative pose and an initial relative pose being greater than a first threshold, determining that the target object is held and setting the target object to a held state.

12. The object movement detection apparatus of claim 11, wherein the processor is further configured to execute the following operations:
calculating the initial relative pose between an initial target pose of the target object and an initial reference pose of the reference object, wherein the initial target pose and the initial reference pose are measured when the target object is in an initial state; and
after calculating the initial relative pose, setting the target object to the detecting state.

13. The object movement detection apparatus of claim 12, wherein the processor is further configured to execute the following operations:
calculating a plurality of first relative poses between a plurality of first target poses of the target object and a plurality of first reference poses of the reference object, wherein the first target poses and the first reference poses are measured within a time interval; and
in response to a second difference between the first relative poses being lower than a second threshold, setting the target object to an initial state.

14. The object movement detection apparatus of claim 11, wherein the processor is further configured to execute the following operations:
calculating a held relative pose between a held target pose of the target object and a held reference pose of the reference object, wherein the held target pose and the held reference pose are measured when the target object is in the held state; and
in response to a third difference between the held relative pose and the initial relative pose being lower than a third threshold, setting the target object to the detecting state.

15. The object movement detection apparatus of claim 11, wherein the operation of determining that the target object is held further comprises:
in response to the first difference being greater than the first threshold, determining whether the target object is in a dropped state based on an inertial data of the target object; and
in response to the target object is not in a dropped state, determining that the target object is held and setting the target object to the held state.

16. The object movement detection apparatus of claim 11, wherein the processor is further configured to execute the following operations:
obtaining an inertial data measured by an inertial measurement unit of the target object; and
in response to the inertial data being greater than an inertial threshold, setting the target object to a dropped state.

17. The object movement detection apparatus of claim 11, wherein the processor is further configured to execute the following operations:
calculating a dropped relative pose between a dropped target pose of the target object and a dropped reference pose of the reference object, wherein the dropped target pose and the dropped reference pose are measured when the target object is in a dropped state; and
in response to a fourth difference between the dropped relative pose and the initial relative pose being lower than a fourth threshold, setting the target object to the detecting state.

18. The object movement detection apparatus of claim 11, wherein the processor is further configured to execute the following operations:
in response to setting the target object to a dropped state, obtaining an inertial data measured by an inertial measurement unit of the target object;
determining whether the target object is moved based on the inertial data; and
in response to determining the target object is moved, setting the target object to the held state.

19. The object movement detection apparatus of claim 11, wherein the processor is further configured to execute the following operation:
in response to setting the target object to the held state, determining an object pose of the target object based on a part posture of a user.

20. A non-transitory computer readable storage medium, having a computer program stored therein, wherein the computer program comprises a plurality of codes, the computer program executes an object movement detection method after being loaded into an electronic apparatus, the object movement detection method comprises:
calculating a detected relative pose between a detected target pose of a target object and a detected reference pose of a reference object, wherein the detected target pose and the detected reference pose are measured when the target object is in a detecting state; and
in response to a first difference between the detected relative pose and an initial relative pose being greater than a first threshold, determining that the target object is held and setting the target object to a held state.
